(19) United States
(12) Patent Application Publication
(10) Pub. No.: US 2025/0369426 A1
(43) Pub. Date: Dec. 4, 2025

(54) Subsea Power Generation

(71) Applicant: Sapphire Technologies, Inc., Cerritos, CA (US)

(72) Inventors: Jeffrey Earl, Hermosa Beach, CA (US); Freddie Sarhan, Anaheim, CA (US)

(21) Appl. No.: 18/676,253

(22) Filed: May 28, 2024

(51) Int. Cl. F03G 7/05; F03G 7/06

(52) U.S. Cl. CPC F03G 7/05; F03G 7/0633

(57) ABSTRACT

The subject matter of this specification can be embodied in, among other things, a subsea energy recovery system for generating electric power that includes an inlet flow line configured to couple to a subsea tree of a subsea gas well to receive gas produced from the subsea gas well, and a subsea electric power generation system, the subsea electric power generation system configured to reside subsea on a subsea production site of the subsea gas well and including a turbine wheel configured to rotate in response to expansion of the gas, a rotor configured to rotate with the turbine wheel, a stationary electric stator, the rotor and electric stator defining an electric generator configured to generate current, and a hermetically sealed housing enclosing the turbine wheel, the rotor, and the electric stator and hermetically sealed inline in the first flow line.

### TECHNICAL FIELD

This disclosure relates to subsea electrical power generation systems.

### BACKGROUND

Natural gas is one of the principal sources of energy for many of our day-to-day needs and activities. Natural gas is an attractive fossil fuel for its abundance and relative cleanliness. It is produced from wells, typically in rural areas, away from national, regional, or municipal power grids and other ready sources of electricity. In the case of subsea natural gas wells, the well production is piped to offshore platforms far from populated areas. Thus, if electricity is needed at the production site (including offshore platform) it is typically made on site by burning a portion of the produced gas.

### SUMMARY

In general, this document describes subsea electrical power generation systems.

In a general example, a subsea energy recovery system for generating electric power includes an inlet flow line configured to couple to a subsea tree of a subsea gas well to receive gas produced from the subsea gas well, and a first flow line coupled to the inlet flow line and configured to receive the gas and comprising a subsea electric power generation system, the subsea electric power generation system configured to reside subsea on a subsea production site of the subsea gas well and including a turbine wheel configured to receive the gas and rotate in response to expansion of the gas flowing into an inlet of the turbine wheel and out of an outlet of the turbine wheel, a rotor coupled to the turbine wheel and configured to rotate with the turbine wheel, a stationary electric stator, the rotor and electric stator defining an electric generator configured to generate current upon rotation of the rotor within the electric stator, and a hermetically sealed housing enclosing the turbine wheel, the rotor, and the electric stator and hermetically sealed inline in the first flow line so that received flow flows through the turbine wheel and over the electric stator, and a second flow line coupled to the inlet flow line to receive the gas and provide an alternate flow path for the gas around the subsea electric power generation system, the second flow line comprising a pressure control valve, and where the first flow line and the second flow line are coupled downstream of the subsea electric power generation system to recombine flow from the first and the second flow lines.

Various embodiments can include some, all, or none, of the following features. The rotor can include a permanent magnet rotor. The subsea energy recovery system can include a flow control valve in the first flow line upstream of the subsea electric power generation system. The inlet flow line can be configured to directly couple to the subsea tree to receive gas produced from the subsea gas well. The electric generator can be configured provide generated current to one or more of the subsea trees, a subsea gas manifold, a subsea gas connection control system, or an electrical load at or above a surface of water. The inlet flow line can be configured to couple to the subsea tree through an intermediary subsea gas manifold configured to couple the inlet flow line to a plurality of subsea trees of a plurality of subsea gas wells to receive gas produced from the plurality of subsea gas wells.

In another general example, a method of recovering energy and generating power from a flow from a subsea gas well includes receiving flow from the subsea gas well at a first flow line comprising a subsea electric power generation system residing on a subsea production site of the subsea gas well and having a turbine wheel configured to receive gas produced from the subsea gas well and rotate in response to expansion of the gas flowing into an inlet of the turbine wheel and out of an outlet of the turbine wheel, an rotor coupled to the turbine wheel and configured to rotate with the turbine wheel, a stationary electric stator, the rotor and electric stator defining an electric generator configured to generate current upon rotation of the rotor within the electric stator, and a hermetically sealed housing enclosing the turbine wheel, the rotor, and the electric stator and hermetically sealed inline in the first flow line so that received flow flows through the turbine wheel and over the electric stator, flowing at least a first portion of the flow from the subsea gas well through the first flow line and the subsea electric power generation system, rotating, by the first portion, the turbine wheel and the rotor, generating current based on rotation of the rotor within the electric stator, receiving a second portion of flow from the subsea gas well at a second flow line configured to provide an alternate flow path for the gas around the subsea electric power generation system, controlling a flow control valve in the first flow line and a pressure control valve in the second flow line, flowing the second portion through the second flow line, and recombining the first portion and the second portion downstream of the subsea electric power generation system.

Various implementations can include some, all, or none of the following features. The hermetically sealed housing can be hermetically sealed to a remainder of the first flow line. The rotor can be a permanent magnet rotor. The flow control valve in the first flow line can be arranged upstream of the subsea electric power generation system. The inlet can be configured to directly couple to a subsea tree to receive gas produced from the subsea gas well. Receiving flow from the subsea gas well at the first flow line having the subsea electric power generation system residing on the subsea production site of the subsea gas well can include receiving, at an inlet flow line directly coupled to the subsea gas well, gas produced from the subsea gas well. The method can include providing generated current to one or more of a subsea gas well control system, a subsea gas manifold control system, a subsea gas connection control system, or an electrical load at or above a surface of water. Receiving flow from the subsea gas well at the first flow line can include receiving flow from a subsea gas manifold coupled to a plurality of subsea trees of a plurality of subsea gas wells and configured to receive gas produced from the plurality of subsea gas wells.

In another general example, a subsea gas well system includes a collection of subsea gas wells, a subsea gas manifold configured to receive gas produced from the plurality of subsea gas wells, and a subsea energy recovery system for generating electric power, the subsea energy recovery system having an inlet flow line configured to couple to a subsea tree of a subsea gas well to receive gas produced from the subsea gas well, and a first flow line coupled to the inlet flow line and configured to receive the gas and comprising a subsea electric power generation system, the subsea electric power generation system configured to reside on a subsea production site of the subsea gas well and having a turbine wheel configured to receive the gas and rotate in response to expansion of the gas flowing into an inlet of the turbine wheel and out of an outlet of the turbine wheel, a rotor coupled to the turbine wheel and configured to rotate with the turbine wheel, a stationary electric stator, the rotor and electric stator defining an electric generator configured to generate current upon rotation of the rotor within the electric stator, and a hermetically sealed housing enclosing the turbine wheel, the rotor, and the electric stator and hermetically sealed inline in the first flow line so that received flow flows through the turbine wheel and over the electric stator, and a second flow line coupled to the inlet flow line to receive the gas and provide an alternate flow path for the gas around the subsea electric power generation system, the second flow line comprising a pressure control valve, and where the first flow line and the second flow line are coupled downstream of the subsea electric power generation system to recombine flow from the first and the second flow lines.

Various embodiments can include some, all, or none of the following features. The rotor can include a permanent magnet rotor. The subsea gas well system can include a flow control valve in the first flow line upstream of the subsea electric power generation system. The inlet flow line can be configured to directly couple to the subsea tree to receive gas produced from the subsea gas well. The electric generator can be configured provide generated current to one or more of one or more of the plurality of subsea gas wells, the subsea gas manifold, a subsea gas well control system configured to control one or more of the plurality of subsea gas wells, a subsea gas manifold control system configured to control the subsea gas manifold, a subsea gas connection control system, or an electrical load at or above a surface of water.

The systems and techniques described here may provide one or more of the following advantages. First, a system can provide efficient power generation based on the inherent stored kinetic energy of naturally pressurized natural gas reserves. Second, the system can generate electrical power undersea, near subsea points of use. Third, the system can increase power efficiency by reducing the length of power cables used to provide power to subsea gas production site equipment. Fourth, the system can produce natural gas and electric power at the same time. Fifth, the system can produce carbon-free electrical power, without combusting fossil fuel.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram of an electric power generation system in accordance with the concepts herein.

FIG. 2 is a schematic diagram of an example turboexpander system in accordance with the concepts herein.

FIG. 3 is a schematic diagram of an example energy recovery system with an electric power generation system in accordance with the concepts herein.

FIG. 4A is a schematic diagram of another example energy recovery system with two series electric power generation systems in accordance with the concepts herein.

FIG. 4B is a schematic diagram of another example energy recovery system with two parallel electric power generation systems in accordance with the concepts herein.

FIG. 5A is a conceptual diagram of an example subsea energy recovery system with an electric power generation system in accordance with the concepts herein.

FIG. 5B is a conceptual diagram of an example subsea skid.

FIG. 6 is a flow diagram of an example process for operating an example subsea energy recovery system with an electric power generation system in accordance with the concepts herein.

Like reference symbols in the various drawings indicate like elements. The drawings are not to scale.

### DETAILED DESCRIPTION

Natural gas wells produce at high pressure, sometimes as much as 9,000 PSIG (62.05 MPa) or even 15,000 PSIG (103.42 MPa). The pressure of the produced natural gas must be reduced prior to pre-processing, which separates particulates and moisture from the gas, and for transport via pipeline. The pipelines, for example, transport gasses from production sites to processing facilities and from processing facilities to local distribution networks, such as regional, city or district networks or on-site industrial plant networks. The processes at the wellsite and intermediate pressure letdown stations use pressure control valves (i.e., choke or throttle valves) to achieve the required pressure drops, but also waste significant amounts of head pressure energy in the process. Additional pressure control valves can be used at other locations for pressure control within the sub-processes of the processing facilities and within the end user's processes and piping. An energy recovery system, according to the concepts herein, can be used in lieu of or in combination with one or more of these pressure control valves. The system includes a turboexpander (with a generator) that can be installed in-line in a flow line from the wellhead, often in parallel to a bypass flow line with a pressure control valve, to extract the wasted energy from pressure reduction and produce electrical power. The electrical power can be directed to a power grid or elsewhere. For example, some or all of the power can be used at the wellsite (onshore or offshore) to supply or offset the site's power needs, such as powering equipment at the wellsite or platform. Some production sites, especially offshore platforms, have no other source of electric power than that made on site (e.g., by running natural gas-powered generators off the produced gas or by diesel-fueled generators). Thus, the energy recovery system can bring power to production sites without burning carbon-based fuel and creating resultant emissions. In each instance, by recovering lost energy from produced natural gas, the energy recovery system can generate electricity while also reducing CO2 emissions, increasing overall plant efficiency, offsetting electrical costs, and generating additional revenue.

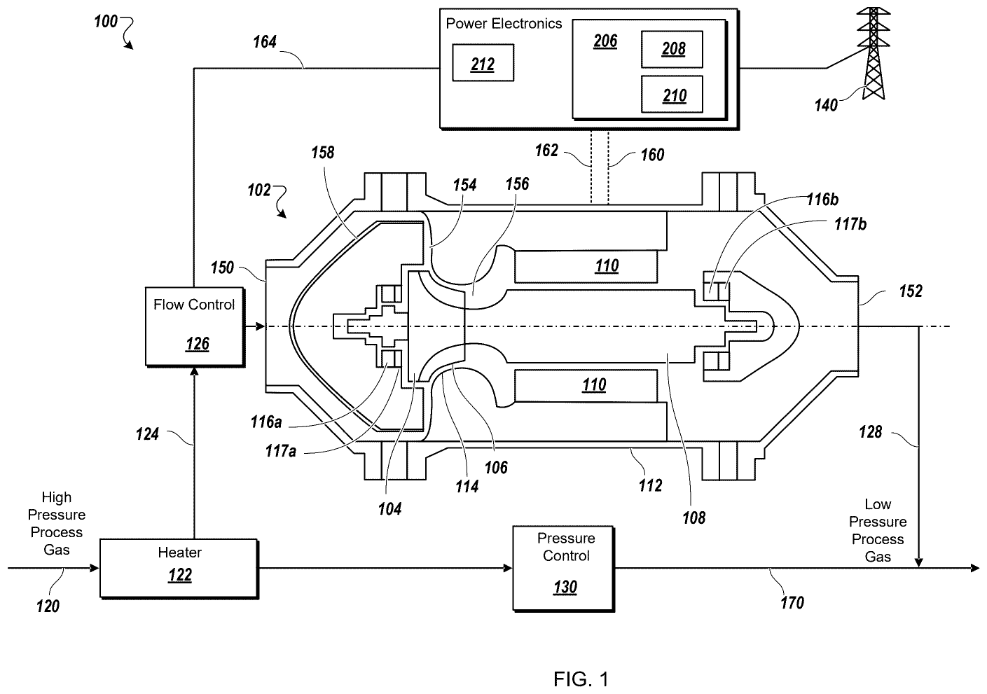

FIG. 1 is a schematic diagram of an electric power generation system 100 coupled to a power grid 140 in accordance with embodiments of the present disclosure. As discussed in more detail below, the grid 140 may be a municipal grid, a microgrid, or the system 100 may be directly coupled to one or more pieces of equipment powered by its output. The electric power generation system 100 includes a turboexpander 102 in parallel with a pressure control valve 130. The turboexpander 102 is arranged axially so that the turboexpander 102 can be mounted in-line with a pipe. The turboexpander 102 acts as an electric generator by converting kinetic energy to rotational energy from gas expansion through a turbine wheel 104 and generating electrical energy. For example, rotation of the turbine wheel 104 can be used to rotate a rotor 108 within a stator 110, which then generates electrical energy.

The turboexpander 102 includes a high-performance, high-speed permanent magnet generator with an integrated radial in-flow expansion turbine wheel 104 and low loss active magnetic bearings (AMBs) 116a,b. The rotor assembly consists of the permanent magnet section with the turbine wheel 104 mounted directly to the rotor hub. The rotor 108 is levitated by the magnetic bearing system creating a frictionless (or near frictionless) interface between dynamic and static components. The AMBs 116a,b facilitate a lossless (or near lossless) rotation of the rotor 108.

The turboexpander 102 includes a high-performance, high-speed permanent magnet generator with an integrated radial in-flow expansion turbine wheel 104 and low loss active magnetic bearings (AMBs) 116a,b. The rotor assembly includes the permanent magnet section with the turbine wheel 104 mounted directly to the rotor hub of the rotor 108. The rotor 108 is levitated by the magnetic bearing system, for example, at longitudinal ends (e.g., axial ends) of the rotor 108, creating a frictionless (or near frictionless) interface between dynamic and static components. The AMBs 116a,b facilitate a lossless (or near lossless) rotation of the rotor 108.

The turboexpander 102 is designed to have the process gas flow through the system, which cools the generator section and eliminates the need for auxiliary cooling equipment. A power electronics module 118 for the turboexpander 102 combines a Variable Speed Drive (VSD) 206 and Magnetic Bearing Controller (MBC) 212 into one cabinet, in some implementations. The VSD allows for a consistent and clean delivery of generated power from the turboexpander 102 to a power grid 140. For example, the VSD 206 regulates the frequency and/or amplitude of the generated current to match the grid and/or power requirements of its load. After expansion, the gas exits the turboexpander 102 along the same axial path for downstream processes.

The turboexpander 102 includes a flow-through configuration. The flow-through configuration permits process gas to flow from an inlet side of the turboexpander 102 to an outlet side of the turboexpander 102, where the inlet and outlet are centered on the same axis. Internally, the gas flows into a radial gas inlet 154 to a turbine wheel 104 and an axial gas outlet 156 from the turbine wheel 104. The gas then flows through the generator and out of the outlet 152, where the gas rejoins the gas pipeline 170. Generally, high pressure process gas 120 is directed to flow into the turboexpander 102 through a flow control system 126. The flow control system 126 includes a flow or mass control valve and an emergency shut off valve. In embodiments, the turboexpander housing 112 is hermetically sealed.

The high-pressure process gas 120 is expanded by flowing through the turbine wheel 104, resulting in a pressure letdown of the process gas. Lower pressure process gas 128 exits the turboexpander 102. The expansion of the high-pressure process gas 120 through the turbine wheel 104 causes the turbine wheel 104 to rotate, which causes the rotor 108 to rotate. The rotation of the rotor 108 within the stator 110 generates electrical energy. The turboexpander 102 achieves the desired pressure letdown and captures the energy from the pressure letdown to generate electricity. A pressure control valve 130, such as a conventional choke, can be installed in parallel to the turboexpander 102. The pressure control valve 130 can be used to control the pressure of the high-pressure process gas 120 that flows in parallel to the turboexpander 102. Any excess high pressure process gas that is not directed into the turboexpander can be directed through the pressure control valve 130.

In some embodiments, a heater 122 can heat the high-pressure process gas 120 prior to flowing the gas into the turboexpander 102. For example, if the expansion of the gas through the turbine wheel 104 would lower the temperature of the process gas to a point where moisture in the gas freezes and/or process gas components condense at, or downstream of, the turbine wheel or at other downstream locations in the pipeline, the pressurized process gas 120 can be heated by heater 122 prior to flowing through the turboexpander 102. Heated high pressure process gas 124 can then be directed into the turboexpander 102. The heating of the process gas can prevent freezing moisture or component condensation as the gas expands and its temperature drops.

The turboexpander 102 includes a turbine wheel 104. The turbine wheel 104 is shown as a radial inflow turbine wheel, though other configurations are within the scope of this disclosure, such as an axial flow turbine. In this example, heated high pressure process gas 124 is received from an inlet conduit 150 of the housing 112 enters a radially oriented inlet 154 of the turbine wheel 104. In certain embodiments, the fluid flows through an inlet conduit 150 and is diverted by a flow diverter 158 to a radial inlet 154 that directs the flow into the radial inflow of the turbine wheel 104. In the example turboexpander 102 of FIG. 1, the flow diverter 158 includes a cone-shaped nose that diverts the gas flow radially outward to the radial inlet 154. The flow diverter 158 can be connected to or integrally formed with the bearing 116a and sensor 117a at the inlet side of the turboexpander 102 and the supports for this bearing 116a and sensor 117a surrounding the axial end of the rotor 108 at the inlet end of the turboexpander 102. After expanding, the lower pressure process gas exits the turbine wheel 104 from an axially oriented outlet 156 to outlet conduit 152 of the housing 112 at the outlet end of the turboexpander 102.

The turbine wheel 104 can be directly affixed to the rotor 108, or to an intermediate common shaft, for example, by fasteners, rigid drive shaft, welding, or other manner. For example, the turbine wheel 104 may be received at an axial end of the rotor 108 and held to the rotor 108 with a shaft. The shaft threads into the rotor 108 at one end, and at the other end, captures the turbine wheel 104 between the end of rotor 108 and a nut threadingly received on the shaft. The turbine wheel 104 and rotor 108 can be coupled without a gearbox and rotate at the same speed. In other instances, the turbine wheel 104 can be indirectly coupled to the rotor 108, for example, by a gear train, clutch mechanism, or other manner.

The turbine wheel 104 includes a plurality of turbine wheel blades 106 extending outwardly from a hub and that react with the expanding process gas to cause the turbine wheel 104 to rotate. FIG. 1 shows an unshrouded turbine wheel, in which each of the turbine blades 106 has an exposed, generally radially oriented blade tip extending between the radial inlet 154 and axial outlet 156. As discussed in more detail below, the blade tips substantially seal against a shroud 114 on the interior of the housing 112. In certain instances, the turbine wheel 104 is a shrouded turbine wheel.

In configurations with an un-shrouded turbine wheel 104, the housing 112 includes an inwardly oriented shroud 114 that resides closely adjacent to, and at most times during operation, out of contact with the turbine wheel blades 106. The close proximity of the turbine wheel blades 106 and shroud 114 substantially seals against passage of process gas therebetween, as the process gas flows through the turbine wheel 104. Although some amount of the process gas may leak or pass between the turbine wheel blades 106 and the shroud 114, the leakage is insubstantial in the operation of the turbine wheel 104. In certain instances, the leakage can be commensurate with other similar unshrouded-turbine/shroud-surface interfaces, using conventional tolerances between the turbine wheel blades 106 and the shroud 114. The amount of leakage that is considered acceptable leakage may be predetermined. The operational parameters of the turboexpander may be optimized to reduce the leakage. In embodiments, the housing 112 is hermetically sealed to prevent process gases from escaping the radial inlet 154 of the turbine wheel 104.

The shroud 114 may reside at a specified distance away from the turbine wheel blades 106 and is maintained at a distance away from the turbine wheel blades 106 during operation of the turboexpander 102 by using magnetic positioning devices, including active magnetic bearings and position sensors.

Bearings 116a and 116b are arranged to rotatably support the rotor 108 and turbine wheel 104 relative to the stator 110 and the shroud 114. The turbine wheel 104 is supported in a cantilevered manner by the bearings 116a and 116b. In embodiments, the turbine wheel 104 may be supported in a non-cantilevered manner and bearings 116a and 116b may be located on the outlet side of turbine wheel 104. In certain instances, one or more of the bearings 116a or 116b can include ball bearings, needle bearings, magnetic bearings, foil bearings, journal bearings, or other bearing types.

Bearings 116a and 116b may be a combination radial and thrust bearing, supporting the rotor 108 in radial and axial directions. Other configurations could be utilized. The bearings 116a and 116b need not be the same types of bearings.

In the embodiments in which the bearings 116a and 116b are magnetic bearings, a magnetic bearing controller (MBC) 212 is used to control the magnetic bearings 116a and 116b. Position sensors 117a, 117b can be used to detect the position or changes in the position of the turbine wheel 104 and/or rotor 108 relative to the housing 112 or other reference point (such as a predetermined value). Position sensors 117a, 117b are connected to the housing 112 directly or indirectly, and the position sensors 117a, 117b can detect axial and/or radial displacement of the rotor 108 and its connected components (e.g., turbine wheel 104) relative to the housing 112. The magnetic bearing 116a and/or 116b can respond to the information from the position sensors 117a, 117b and adjust for the detected displacement, if necessary. The MBC 212 may receive information from the position sensor(s) 117a, 117b and process that information to provide control signals to the magnetic bearings 116a, 116b. MBC 212 can communicate with the various components of the turboexpander 102 across a communications channel 162.

The use of magnetic bearings 116a, 116b and position sensors 117a, 117b to maintain and/or adjust the position of the turbine wheel blades 106 such that the turbine wheel blades 106 stay in close proximity to the shroud 114 permits the turboexpander 102 to operate without the need for seals (e.g., without the need for dynamic seals). The use of the active magnetic bearings 116a,b in the turboexpander 102 eliminates physical contact between rotating and stationary components, as well as the need for lubrication, lubrication systems, and seals.

The turboexpander 102 may include one or more backup bearings. For example, in the event of a power outage that affects the operation of the magnetic bearings 116a and 116b, bearings may be used to rotatably support the turbine wheel 104 during that period of time. The backup bearings and may include ball bearings, needle bearings, journal bearings, or the like.

As mentioned previously, the turboexpander 102 is configured to generate electricity in response to the rotation of the rotor 108. In certain instances, the rotor 108 can include one or more permanent magnets coupled to the rotor 108, for example, on a radially outer surface of the rotor 108 adjacent to the stator 110. The stator 110 includes a plurality of conductive coils, for example, positioned adjacent to the magnet(s) on the rotor 108. Electrical current is generated by the rotation of the magnet(s) within the coils of the stator 110. The rotor 108 and stator 110 can be configured as a synchronous, permanent magnet, multiphase alternating current (AC) generator. The electrical output 160 can be a three-phase output, for example. In certain instances, stator 110 may include a plurality of coils (e.g., three or six coils for a three-phase AC output). When the rotor 108 is rotated, a voltage is induced in the stator coil. At any instant, the magnitude of the voltage induced in the coils is proportional to the rate at which the magnetic field encircled by the coil is changing with time (i.e., the rate at which the magnetic field is passing the two sides of the coil). In instances where the rotor 108 is coupled to rotate at the same speed as the turbine wheel 104, the turboexpander 102 is configured to generate electricity at that speed. Such a turboexpander 102 is what is referred to as a “high speed” turbine generator. For example, in embodiments, the turboexpander 102 can produce up to 135 kilowatts (KW) of power at a continuous speed of 25,000 revolutions per minute (rpm) of the rotor 108. In embodiments, the turboexpander 102 can produce on the order of 315 KW at certain rotational speeds (e.g., on the order of 23,000 rpm).

In some embodiments, the design of the turbine wheel 104, rotor 108, and/or stator 110 can be based on a desired parameter of the output gas from the turboexpander 102. For example, the design of the rotor 108 and stator 110 can be based on a desired temperature of the gas 128 at input of the turboexpander 102, output of the turboexpander 102, or both.

In the example system 100 of FIG. 1, the turboexpander 102 is coupled to the power electronics module 118. The power electronics module 118 includes the variable speed drive (VSD) 206 (or variable frequency drive) and the magnetic bearing controller (MBC) 212 (discussed above).

The electrical output 160 of the turboexpander 102 is connected to the VSD 206, which can be programmed to specific power requirements. The VSD 206 can include an insulated-gate bipolar transistor (IGBT) rectifier 208 to convert the variable frequency, high voltage output from the turboexpander 102 to a direct current (DC). The rectifier 208 can be a three-phase rectifier for three-phase AC input current. An inverter 210 then converts the DC from the rectifier AC for supplying to the power grid 140 (or other load). The inverter 210 can convert the DC to 380 VAC-480 VAC at 50 to 60 Hz for delivery to the power grid. The specific output of the VSD 206 depends on the power grid and application. Other conversion values are within the scope of this disclosure. The VSD 206 matches its output to the power grid 140 by sampling the grid voltage and frequency, and then changing the output voltage and frequency of the inverter 210 to match the sampled power grid voltage and frequency.

The turboexpander 102 is also connected to the MBC 212 in the power electronics module 118. The MBC 212 constantly monitors position, current, temperature, and other parameters to ensure that the turboexpander 102 and the active magnetic bearings 116a and 116b are operating as desired. For example, the MBC 212 is coupled to position sensors 117a, 117b to monitor radial and/or axial position of the turbine wheel 104 and the rotor 108. The MBC 212 can control the magnetic bearings 116a, 116b to selectively change the stiffness and damping characteristics of the magnetic bearings 116a, 116b as a function of spin speed. The MBC 212 can also control synchronous cancellation, including automatic balancing control, adaptive vibration control, adaptive vibration rejection, and unbalance force rejection control.

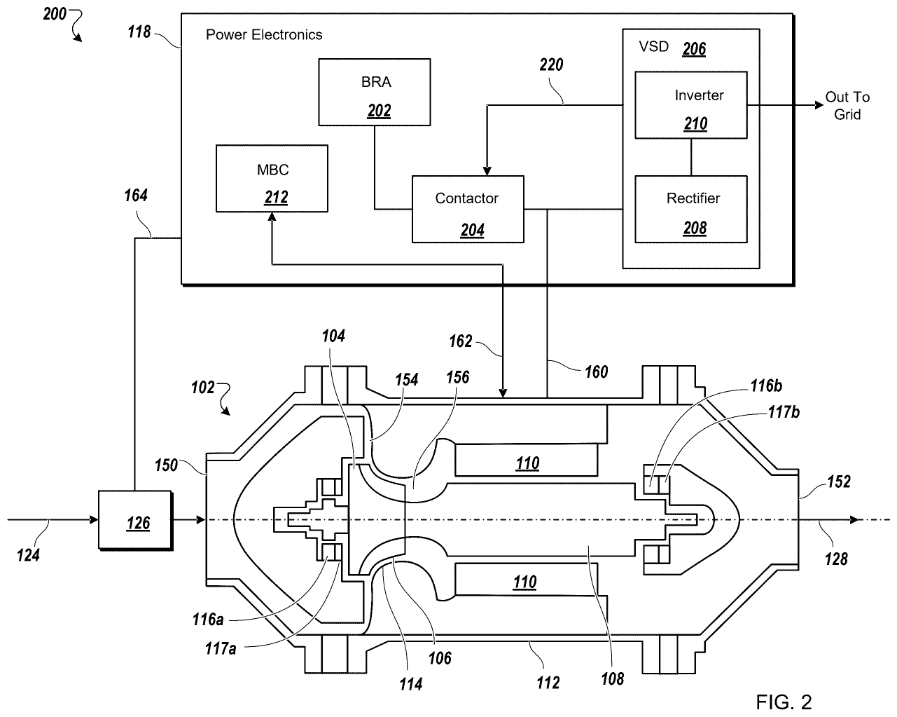

FIG. 2 is a schematic diagram of an example turboexpander system 200 that includes a brake resistor assembly 202 in accordance with embodiments of the present disclosure. Turboexpander system 200 includes the turboexpander 102 and the power electronics module 118. The turboexpander 102 receives a heated high pressure process gas 124, which causes the turbine wheel 104 to rotate. The rotation of the turbine wheel 104 rotates a rotor 108 that supports a plurality of permanent magnets. The rotation of the permanent magnets on the rotor 108 induces a current through coils or windings on stator 110.

The electric generator system acts as a brake on the rotor 108. This braking torque converts the shaft power, created by the process gas flow, to electrical power that can be put on an electrical grid, for example. In the case of a grid or load failure, inverter failure, or other fault condition, braking torque is lost and the rotor 108 may spin up towards an undesirable overspeed. To prevent overspeed, the power can be diverted to a brake resistor assembly 202 that can temporarily absorb the electricity until the process gas flow is reduced or removed (e.g., by flow control system 126) or until the fault condition is resolved. Flow control system 126 can include a one or a combination of a flow control valve or a mass control valve or an emergency shutoff valve. Flow control system 126 can be controlled by the power electronics module 118 or other electrical, mechanical, or electromagnetic signal. For example, a fault condition can signal the flow control system 126 to close or partially close, thereby removing or restricting gas supply to the turboexpander 102. Restricting or removing gas flow to the turboexpander reduces the shaft power developed by the turbine wheel and consequently, slows the rotor. In the example shown in FIGS. 1 and 2, a signal channel 164 from the power electronics module 118 can be used to open and/or close the flow control system 126.

A fault condition can include a grid or load failure, VSD failure, inverter failure, or other fault condition. A fault condition can include any condition that removes or reduces the braking torque on the rotor 108.

A brake resistor assembly 202 is electrically connected to the electrical output 160 of the turboexpander 102 (e.g., the output of the generator). The brake resistor assembly 202 can have a tuned impedance to allow an efficient transfer of power from the turboexpander 102 to the brake resistor assembly 202.

In embodiments, a contactor 204 can connect the output current of the turboexpander 102 to the brake resistor assembly 202 when there is a fault condition at the VSD 206 or the power grid 140. The contactor 204 is an electrically controlled switch for switching in an electrical power circuit. The contactor 204 can accommodate the three-phase current output from the generator to direct the current to the brake resistor assembly 202.

In some embodiments, the contactor 204 is connected directly to the (three-phase) electrical output 160 of the turboexpander 102. In some embodiments, the brake resistor assembly 202 and/or the contactor 204 are not part of the power electronics but are connected to the electrical output 160 of the turboexpander 102 outside of the power electronics module 118.

The VSD 206 can provide an energizing signal 220 to the coil of the contactor 204 to cause the contactor 204 to connect the electrical output 160 of the turboexpander to the brake resistor assembly 202. Depending on the implementation choice, the contactor 204 can be a normally closed (NC) contactor or a normally open (NO) contactor.

For example, in an example implementation using a NO contactor, during normal operating conditions, the electrical output 160 of the turboexpander 102 is connected to the VSD 206 and supplies three-phase AC current to the VSD 206. In a fault condition, the VSD can energize the contactor 204 to connect the contactor 204 to the electrical output 160 of the turboexpander 102. In some implementations, the energizing signal 220 to the contactor 204 can be provided by another source that can respond to a fault condition (e.g., another component of the power electronics module 118 or another component outside the power electronics module 118). In this implementation, if failure of the VSD 206 is the cause of the fault condition, the contactor 204 can operate independent of the VSD 206.

If an NC contactor is used, then the VSD 206 (or other source) provides an energizing signal 220 to the contactor 204 to keep the contactor switches open during normal operating conditions. A fault condition can result in the removal of the energizing signal 220 to the contactor 204, which results in the contactor switches closing and completing the circuit between the electrical output 160 of the turboexpander 102 and the brake resistor assembly 202.

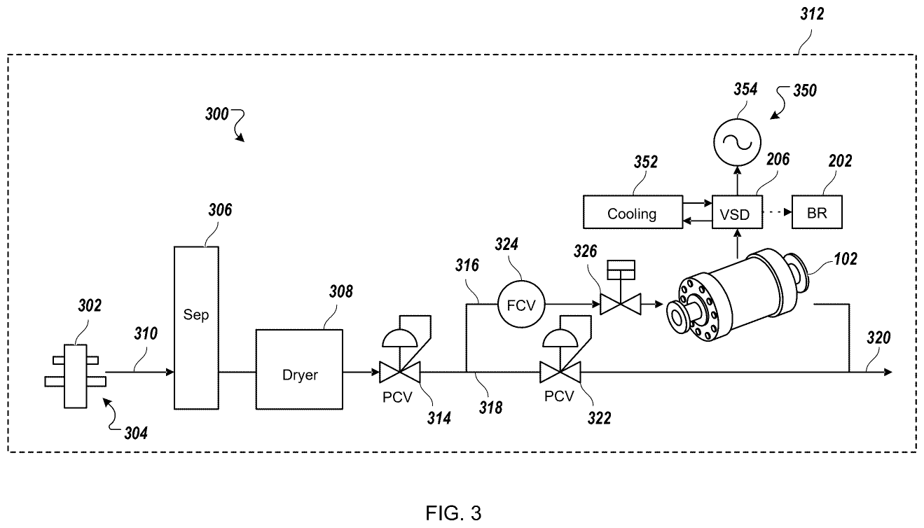

FIG. 3 shows an example energy recovery system 300 coupled to and between a wellhead 302 of a well 304 and a production pipeline 320. The production pipeline 320 is the pipeline that communicates the produced fluids from the well 304 to one or more processing facilities (not show) and ultimately on to the end user. The system 300 includes an electric power generation system 350, with a turboexpander 102 (with generator), for recovering energy from reducing the pressure of the produced fluids from the well 304, as well as associated flow lines and other equipment. In certain instances, the system 300 resides at a subsea production site 312 (e.g., the ocean floor, lakebed, riverbed), in proximity to the wellhead 302. In certain instances, the system 300 resides on or off the subsea production site 312, upstream of the production pipeline 320. In one example of a land based well 304, the subsea production site 312 is, and the system 300 resides on, the site with the other near well 304 equipment, upstream of the production pipeline 320. In another example, multiple land-based wells 304 are on the same subsea production site 312 feeding to the same pipeline 320, and the system 300 is coupled to one or more of the wells 304 and resides on the subsea production site 312.

In certain instances, the electric power generation system 350 is the same as the electric power generation system 100. With reference to FIGS. 1 and 2, the system 350 includes, among other things of system 100, the above described turboexpander 102 in a hermetic housing 112, the electrical output of the generator of the turboexpander 102 being coupled to the power electronics module 118, including a VSD 206 with, in some instances, a brake resistor assembly 202. The turboexpander 102 can be configured to handle the gas conditions produced by the well 304, for example, configured to handle a specified amount of liquid in the gas, particulate in the gas, as well as to be resistant to corrosive aspects (e.g., hydrogen sulfide) in the gas. In certain instances, the VSD 206 can be coupled to a cooling system 352 to cool the electronics of the VSD 206 to maintain temperatures below a specified operating temperature. The output of the VSD 206 can be electrically coupled to a load 354, such as a power grid to supply power to the grid, as described above, a microgrid at the subsea production site 312 for supplying power to equipment used for producing or treating gas at the subsea production site 312, and/or directly to one or more pieces of equipment used for producing or treating gas at the subsea production site 312 to supply power to the equipment. In certain instances, the equipment includes flow, pressure, temperature, and level sensors of various equipment, valve actuators, communications equipment for allowing remote communication with the sensors, other equipment and control of the valve actuators, separators (e.g., sand separators, liquid separators), heater treaters, site lighting, control trailers and/or other types of equipment. In certain instances, the electricity produced by the electric power generation system 350 can be used by other equipment at the subsea production site 312 not involved in producing or treating the gas from the well 304. For example, the electricity can be used to power a hydrogen electrolyzer in a process on the subsea production site 312 for producing hydrogen from the water.

The system 300 includes an inlet flow line 310 coupled to an outlet of the wellhead 302. Well production, which is primarily gaseous natural gas (but often also has some oil, water, moisture, and particulate), flows from the wellhead 302, and flows through flow line 310. The flow line 310 includes flow conditioning equipment to condition the flow to specified conditions selected based on the specification of pipeline 320 and equipment downstream of the subsea production site 312, as well as based on the characteristics of the turboexpander 102 of the electric power generation system 350. In FIG. 3 the conditioning equipment is shown as a solids and liquids separator 306 and a dryer 308, but the conditioning equipment could include additional, different, or fewer pieces and types of equipment. For example, the conditioning equipment can include separators, molecular dryers, knock-out drums, two-phase coalescers and/or other types of conditioning equipment. Turning back to the specific example of FIG. 3, flow in flow line 310 flows from the wellhead 302 to and through the separator 306. In the separator 306, solids and liquids are separated from the gaseous flow. Thereafter, the flow flows through the flow line 310 to the dryer 308, where it is dried to reduce moisture in the flow to a specified level selected (in part or entirely) based on the specification of the turboexpander 102 of the electric power generation system 350. From the dryer 308, the flow flows through the flow line 310 to a pressure control valve 314. The pressure control valve 314 can be controlled to reduce the pressure of the gas flow to a specified pressure. Each of the valves herein, whether control or isolation or other, can be remote controlled, e.g., via an operator at a remote control board on the subsea production site 312 or elsewhere or both, and/or autonomously controlled by a control algorithm of a controller residing at the subsea production site 312 or elsewhere or both.

Flow from the pressure control valve 314 is split into a first downstream flow line 316 that includes an electric power generation system 350, including a turboexpander 102, and a second downstream flow line 318 that bypasses the turboexpander 102. The first downstream flow line 316 and second downstream flow line 318 recombine flow upstream of the production pipeline 320 before leaving the subsea production site 312. The inlet of the hermetic housing 112 is hermetically coupled in-line with first flow line 316 so that all fluid in the flow line 316 is directed into the hermetic housing 112, flows through the housing 112, and back into the remainder of first flow line 316.

The second flow line 318 includes a pressure control valve 322 (e.g., pressure control valve 130) configured with a specified pressure drop to actuation position correlation. The pressure control valve 322 can be controlled to regulate the pressure in the second flow line 318 downstream of the valve 322, and in turn (as a function of the pressure of the flow coming from the well) the pressure upstream of the pressure control valve 322 and the pressure in the first flow line 316. The first flow line 316 includes a flow control valve 324 (e.g., flow control valve 126), configured with a specified flow rate to actuation position correlation. The flow control valve 324 can be controlled in relation to the pressure control valves 314, 322 to control the flow rate of fluid flowing through the first flow line 316, and thus the flow rate of flowing through the turboexpander 102.

This arrangement positions the turboexpander 102 in parallel to the second flow line 318, and, as will be discussed in more detail below, allows freedom in sizing the turboexpander 102 relative to the pressure and flow rate of flow produced from the well 304 as well as relative to the conditions of the pipeline 320. The freedom stems, in part, from the second flow line 318 allowing flow to selectively bypass the turboexpander 102 in flowing from the wellhead 302 to the production pipeline 320. In short, however, all flow need not pass through the turboexpander 102 in flowing from the wellhead 302 to the pipeline 320, so the turboexpander 102 need not be sized to receive all of the flow. The first flow line 316 also includes an emergency shut-off valve 326 upstream of the turboexpander 102 to quickly shut off flow to the turboexpander 102, if needed. When closed, the entirety of the flow flows through the second flow line 318. Notably, although not shown, the inlet flow line 310, first flow line 316 and second flow line 318 can additionally be instrumented with sensors to monitor the pressure, temperature, flow rate, and/or other characteristics of the flow in each line and upstream and/or downstream of each component (e.g., valves, turboexpander and other components in the flow lines).

In operation, when the well 304 is new and first put on production, the fluids produced from the well 304 are at or near their highest pressure and flow rate. Over time, the pressure of the produced fluids declines, as does the flow rate of the produced fluids. Thus, pressure of the production flow is regulated with the pressure control valve 314 in the flow line 310 to a specified pressure. The pressure control valve 322 in the second flow line 318 is, in turn, controlled to maintain the pressure through the first flow line 316 and through the turboexpander 102 so that together with the flow control valve 324 the conditions through the turboexpander 102 are maintained within the turboexpander's specified operating range. Excess flow exits the second flow line 318 and is directed to the pipeline 320. The flow through the first flow line 316 flows through the turboexpander 102, generating power, and then back to recombine with the flow from the second flow line 318 and on to the pipeline 320.

The characteristics of the turboexpander 102 are selected based on a number of factors, including the expected pressures, temperatures and flow rates that can be maintained by the well 304 over time, the timeframe during the life of the well 304 that power generated by the turboexpander 102 is desired or needed (e.g., whether the power is needed at the outset of the well's life, over as much of the well's life as is feasible, or only at the tail of the well's life), the ambient conditions at the subsea production site 312, the efficiency/performance of the solids and liquids separator 306 and dryer 308, the conditions, including pressure, temperature and/or flow rate, specified for receipt by the pipeline 320 (often specified by the pipeline operator), and the amount of electricity desired or needed to be produced at the subsea production site 312 by the turboexpander 102. The specified pressure to which the pressure control valve 314 is controlled is, in turn, selected based on a number of factors, including the pressure, temperature and flow characteristics of the turboexpander 102, the amount of electricity desired or needed to be produced, as well as the pressure, temperature and/or flow rate, specified for receipt by the pipeline 320. For example, in certain instances, the pipeline 320 is configured to operate at a specified pressure. The turboexpander 102, which causes a pressure drop as it extracts energy from the flow, is configured to, in cooperation with the pressure control valves 314, 322 produce an outlet pressure out of the turboexpander 102 equal to the specified pressure of the pipeline 320. In certain instances, the pipeline 320 also has a specified minimum temperature, for example a temperature selected to prevent freezing of the fluids in the pipeline. The turboexpander 102, which causes a temperature drop as it extracts energy from the flow, is configured to, in cooperation with the pressure control valves 314, 322 (which also causes a temperature drop), maintain an outlet temperature of the turboexpander 102 and at the entrance to the pipeline 320 at the specified pressure at or above the specified minimum temperature. Providing a numerical example, in certain instances, the pressure of the well can be initially 9,000 PSIG (62.05 MPa) or higher and the flow is regulated down to 1,600 PSIG (11.03 MPa) using the pressure control valve 314. As the well 304 ages, and the pressure declines, this 1,600 PSIG (11.03 MPa) can be maintained until the well's pressure drops below 1,600 PSIG (11.03 MPa). While the well is above 1,600 PSIG (11.03 MPa), the turboexpander 102, which can be optimized to operate at peak efficiency under the pressure, temperature and flow conditions offered by the well 304 during this time, operates to generate electricity, while also providing and maintaining a further pressure drop downstream of the turboexpander 102 to the specified pressure of the pipeline 320. The hotter the well, the more energy available for the turboexpander 102 to extract. As the well 304 pressure drops below 1,600 PSIG (11.03 MPa), the efficiency of the turboexpander 102 drops off until the well conditions can no longer operate the turboexpander 102 sufficiently. Thereafter, the first flow line 316 is shut off and flow is directed through only the second flow line 318, so that the turboexpander 102 does not provide an additional pressure drop. In certain instances, the turboexpander 102 is configured to produce usable amounts of electricity until the pressure upstream approaches the pipeline's specified pressure. Often times, this specified pressure is 1,000 PSIG (6.89 MPa).

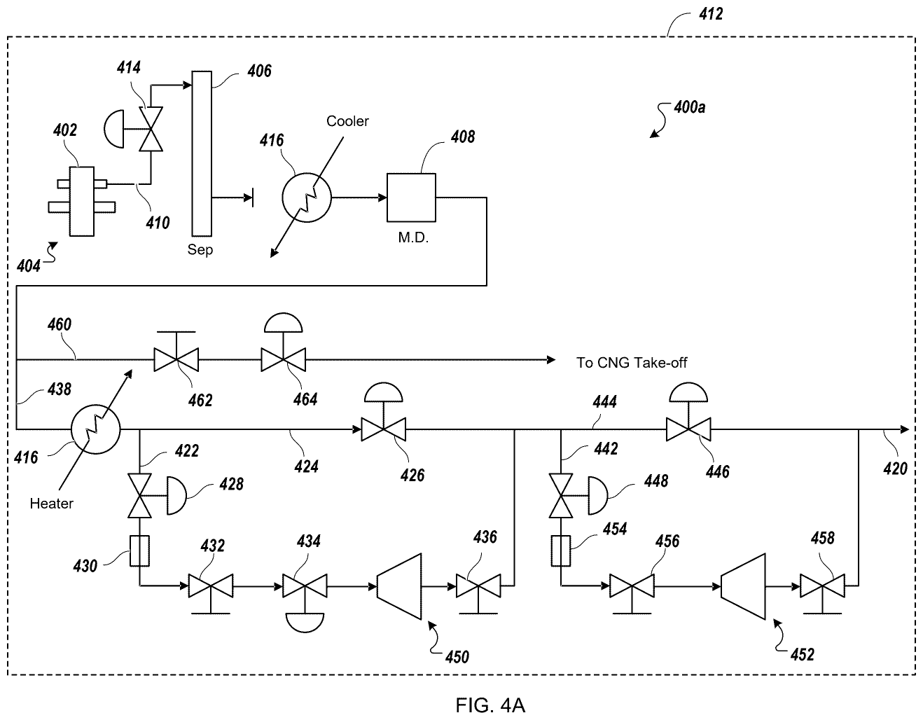

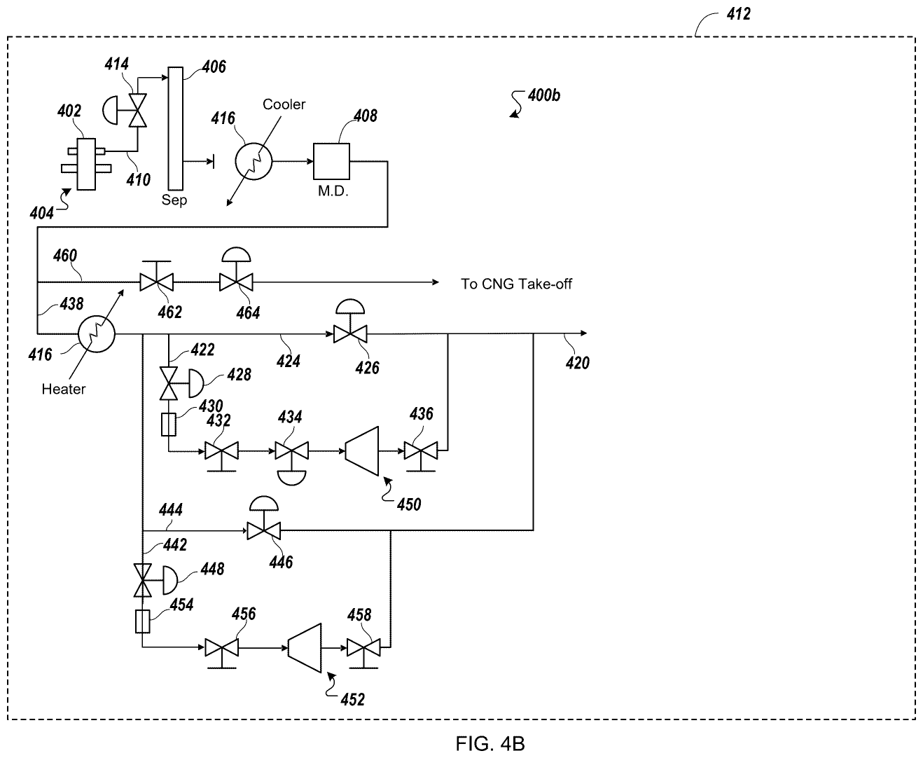

FIG. 4A is another example energy recovery system 400a coupled to and between a wellhead 402 of a well 404 (or multiple wells, in some cases) and a production pipeline 420 at a subsea production site. This second example energy recovery system 400a is more full-featured than the example energy recovery system 300 discussed with respect to FIG. 3. For example, this second example energy recovery system 400a is shown with two electric power generation systems 450, 452 arranged in series. As with system 300, this second example system 400a resides at a subsea production site 412 (e.g., the ocean floor, lakebed, riverbed), in proximity to the wellhead 402 and/or upstream of the production pipeline 420. In certain instances, one or both of the electric power generation systems 450, 452 are the same as the electric power generation system 100. But, as will be discussed in more detail below, the electric power generation systems 450, 452 can have the same or different operational characteristics from one another.

The system 400a includes an inlet flow line 410 coupled to the outlet of the wellhead 402. The well production flows from the wellhead 402 into the flow line 410. As above, the flow line 410 includes flow conditioning equipment show in this instance as including a solids and liquid separator 406 and a dryer 408. The system 400a also is shown with a heat exchanger 416, the cool side of which is shown receiving the flow upstream from the dryer 408. Additional, different, or fewer pieces and types of flow conditioning equipment may be provided. A pressure control valve 414 is shown between the wellhead 402 and the separator 406, but it could be elsewhere in the system upstream of the electric power generation systems 450, 452. After the dryer 408 the flow is split to a compressed natural gas (CNG) take-off line 460 and a production path line 438 leading to the production pipeline 420.

The line 460 includes an isolation valve 462 and a pressure control valve 464. The isolation valve 462, when closed, seals the line 460 and allows the CNG take-off line 460 to be shut off so that all flow flows only to the production path line 460. The pressure control valve 464 allows the pressure to the CNG take-off to be regulated.

The production path line 438 has two electric power generation systems 450, 452. Flow enters this portion of the system passing through the hot side of the heat exchanger 416 to collect heat from (i.e., cool) the hotter flow upstream of the dryer 408. The flow is then split into a first flow line 422 that includes the electric power generation system 450 and a second flow line 424 that bypasses the electric power generation system 450. The first flow line 422 and the second flow line 424 converge downstream of the electric power generation system 450. The second flow line 424 includes a pressure control valve 426 (e.g., pressure control valve 130). The first flow line 422 includes a flow control valve 428 (e.g., flow control valve 126) upstream of a flow meter 430. Thereafter, the first flow line 422 includes an isolation valve 432 that can be closed to cease flow into the first flow line 422 and the electric power generation system 450. The first flow line 422 also includes a pressure control valve 434. After the electric power generation system 450 an additional isolation valve 436 is provided to allow the electric power generation system 450 to be completely closed in and prevent backflow to the electric power generation system 450.

The flow is then split again into a third flow line 442 that includes the electric power generation system 452 and a fourth flow line 444 that bypasses the electric power generation system 452. The third flow line 442 and the fourth flow line 444 converge downstream of the electric power generation system 452, and the flow continues on to the pipeline 420. The fourth flow line 444 includes a pressure control valve 446 (e.g., pressure control valve 130). The third flow line 442 includes a flow control valve 448 (e.g., flow control valve 126) upstream of a flow meter 454. Thereafter, the third flow line 442 includes an isolation valve 456 that can be closed to cease flow into the third flow line 442 and the electric power generation system 452. After the electric power generation system 452 an additional isolation valve 458 is provided to allow the electric power generation system 452 to be completely closed in and prevent backflow to the electric power generation system 452.

While the two electric power generation systems 450, 452 can be identically configured, in certain instances, the turboexpanders and/or the electronics of the electric power generation systems 450, 452 can be differently configured. The same design considerations discussed above for the turboexpander of electric power generation system 350 and the pressure regulation by pressure control valve 314 (FIG. 3) can apply to the turboexpanders of the two electric power generation systems 450, 452 and pressure control valve 414, with the further caveat that the electric power generation system 450 can take into account the desired or needed inlet conditions for electric power generation system 452. For example, the turboexpander of the upstream electric power generation system 450 can be configured, and the pressure control valve 414 controlled, so that the conditions at the outlet of the turboexpander are within, and preferable at or near the upper limit of, the operating pressure range of the turboexpander of downstream electric power generation system 452. In certain instances, the turboexpander of the upstream electric power generation system 450 can be configured to handle and be more efficient than the turboexpander of the downstream electric power generation system 452 at higher pressures, temperatures and/or flow rates. Configuring the upstream turboexpander in this manner allows more ready use of the declining pressures produced by the well over its life. For example, in the embodiment of FIG. 3, when the pressure produced by the well 304 is greater than can be handled by the turboexpander of the electric power generation system 350, the pressures are regulated down to the efficient operating pressure range of the turboexpander, effectively decreasing the amount of energy available in the flow for conversion into electric power. If the turboexpander were to be configured to have a higher operating pressure range, the lower end of the operating pressure range would also likely increase. Thus, as the well pressure declines, the point at which the well pressure will no longer efficiently drive the turboexpander of the electric power generation system 350 would be reached sooner in the well's life. By configuring the turboexpander of the upstream electric power generation system 450 to operate at higher pressures, for example, the system 400a can generate more electric power by harnessing the higher pressures with the turboexpander of the electric power generation system 450. Then, as the pressures decline to the point at which the well pressure will no longer efficiently drive the turboexpander of the electric power generation system 450, the electric power generation system 450 can be isolated from the flow, and electric power generated at lower pressures with only the turboexpander of the downstream electric power generation system 452. Notably, although the system 400a is described herein with only two electric power generation systems, additional, such as three, four or more could be provided, each with two separate flow paths and the valves as described above. Two or more in the set could be identically configured or all could be differently configured, for example, with successively lower operating ranges for each downstream electric power generation system. In some embodiments, there may be additional power generation systems installed in parallel to each other at one or more operating regimes.

In operation, flow from the wellhead 402 is regulated down in pressure to a specified pressure by the pressure regulation valve 414. The fluid then flows through the flow conditioning system (e.g., the separator 406 and dryer 408) and is cooled by cool side of the heat exchanger 416 (transferring heat to the flow downstream in the system). If the CNG take-off is operating (i.e., isolation valve 462 is open), a portion of the flow is directed to the CNG take-off line 460, and the remainder of the flow continues on to the production path line 438. The pressure of the fluid supplied to the CNG take-off can be regulated to specified pressure by the pressure control valve 464.

In the production path line 438, the heat exchanger 416 heats the fluid (transferring heat from the flow upstream in the system). Thereafter, if the two isolation valves 434, 436 in the first flow line 422 are open, the flow is split into the first flow line 422 and second flow line 424. If one or both of the isolation valves 434, 436 are closed, the flow bypasses the first flow line 422 and continues to flow through the second flow line 424. In an instance where the flow is split between the first flow line 422 and the second flow line 424, the pressure control valve 426, pressure control valve 434 and flow control valve 428 are controlled to control the amount of flow that flows into the first flow line 422, and thus the turboexpander of the electric power generation system 450. Flow leaving the turboexpander of the electric power generation system 450 is recombined with the flow in the second flow line 424.

If both isolation valves 456, 458 in the third flow line 442 are open, the flow is split between the third flow line 442 and the fourth flow line 444. If one or both of the isolation valves 456, 458 in the third flow line 442 are closed the flow bypasses the turboexpander of the electric power generation system 452. In an instance where the flow is split between the third flow line 442 and the fourth flow line 444, the pressure control valve 446 and flow control valve 448 are operated to control the amount of flow that flows into the third flow line 442 and thus the turboexpander of the electric power generation system 452. Flow leaving the turboexpander of the electric power generation system 452 is recombined with the flow from the fourth flow line 444 and then proceeds to the pipeline 420 at the specified pressure of the pipeline 420.

When the well is new and the production pressure is high, both turboexpanders of both electric power generation systems 450, 452 can be operated. As the well pressure declines, if the turboexpander of the electric power generation system 450 is configured to run at a higher pressure than the turboexpander of the electric power generation system 452, the pressure of flow may become too low to effectively operate the electric power generation system 450. In this case, the isolation valves 432, 436 can be closed and flow bypassed through the second flow line 424 to the electric power generation system 452. The electric power generation system 452 can thereafter continue to operate until the well pressure declines to a point at which the turboexpander of the electric power generation system 452 can no longer be effectively operated. Thereafter, the isolation valves 456, 458 can be closed and flow bypassed through the fourth flow line 444 to the pipeline 420. Providing a numerical example, in certain instances, the pressure of the well can be initially 9,000 PSIG (62.05 MPa) or higher and the flow is regulated down to 3,600 PSIG (24.82 MPa) using the pressure control valve 414. As the well 404 ages, and the pressure declines, this 3,600 PSIG (24.82 MPa) can be maintained until the well's pressure drops below 3,600 PSIG (24.82 MPa). While the well is above 3,600 PSIG (24.82 MPa), both electric power generations systems 450, 452 can be operated to generate electricity, while also providing and maintaining a further pressure drop to the specified pressure of the pipeline 420. In the example, the upstream electric power generation system 450 is configured to depressurize the 3,600 PSIG (24.82 MPa) flow to 1,600 PSIG (11.03 MPa), and so the pressure control valve 426 is also controlled to this pressure. Also, in this example, the turboexpander of the downstream electric power generation system 452 is configured to receive an inlet pressure of 1,600 PSIG (11.03 MPa). As the well 404 pressure drops below 3,600 PSIG (24.82 MPa), the efficiency of the turboexpander of the upstream electric power generation system 450 drops off until the well conditions can no longer operate the turboexpander sufficiently. Thereafter the first flow line 422 is shut off by closing the isolation valves 432, 436 and flow is only directed through the second flow line 424. The second electric power generation system 452 continues to operate with the pressure control valve 426 (or optionally the pressure control valve 414) maintaining pressure to the third flow line 442 and fourth flow line 444 at 1,600 PSIG (11.03 MPa). As the well 404 pressure drops below 1,600 PSIG (11.03 MPa), the efficiency of the turboexpander of the downstream electric power generation system 452 drops off until the well conditions can no longer operate the turboexpander sufficiently. Thereafter, the third flow line 442 is shut off by closing isolation valves 456, 458 and flow is directed through only the fourth flow line 444, so that the turboexpander does not provide an additional pressure drop. In certain instances, the turboexpander of the downstream electric power generation system 452 is configured to produce usable amounts of electricity until the pressure upstream approaches the pipeline's specified pressure. Often times, this specified pressure is 1000 PSIG (6.89 MPa).

FIG. 4B is another example energy recovery system 400b coupled to and between the wellhead 402 of the well 404 (or multiple wells, in some cases) and the production pipeline 420 at the subsea production site 412. This third example energy recovery system 400b is substantially the same as the example energy recovery system 400a, except this third example energy recovery system 400b is shown with two electric power generation systems 450, 452 arranged in parallel. As discussed in previous paragraphs, one or both of the electric power generation systems 450, 452 are the same as the electric power generation system 100, or the electric power generation systems 450, 452 can have the same or different operational characteristics from one another.

The production path line 438 has the two electric power generation systems 450, 452. Flow enters this portion of the system passing through the hot side of the heat exchanger 416 to collect heat from (i.e., cool) the hotter flow upstream of the dryer 408. The flow is then split into a first flow line 422 that includes the electric power generation system 450 and a second flow line 424 that bypasses the electric power generation system 450. The first flow line 422 and the second flow line 424 converge downstream of the electric power generation system 450 and the flow continues on to the pipeline 420. The second flow line 424 includes a pressure control valve 426 (e.g., pressure control valve 130). The first flow line 422 includes a flow control valve 428 (e.g., flow control valve 126) upstream of a flow meter 430. Thereafter, the first flow line 422 includes an isolation valve 432 that can be closed to cease flow into the first flow line 422 and the electric power generation system 450. The first flow line 422 also includes a pressure control valve 434. After the electric power generation system 450 an additional isolation valve 436 is provided to allow the electric power generation system 450 to be completely closed in and prevent backflow to the electric power generation system 450.

Flow from the heat exchanger 416 is also split into a third flow line 442 that includes the electric power generation system 452 and a fourth flow line 444 that bypasses the electric power generation system 452. The third flow line 442 and the fourth flow line 444 converge downstream of the electric power generation system 452, and the flow continues on to the pipeline 420. The fourth flow line 444 includes a pressure control valve 446 (e.g., pressure control valve 130). The third flow line 442 includes a flow control valve 448 (e.g., flow control valve 126) upstream of a flow meter 454. Thereafter, the third flow line 442 includes an isolation valve 456 that can be closed to cease flow into the third flow line 442 and the electric power generation system 452. After the electric power generation system 452 an additional isolation valve 458 is provided to allow the electric power generation system 452 to be completely closed in and prevent backflow to the electric power generation system 452.

While the two electric power generation systems 450, 452 can be identically configured, in certain instances, the turboexpanders and/or the electronics of the electric power generation systems 450, 452 can be differently configured. The same design considerations discussed above for the turboexpander of electric power generation system 350 and the pressure regulation by pressure control valve 314 (FIG. 3) can apply to the turboexpanders of the two electric power generation systems 450, 452 and pressure control valve 414, with the further caveat that the electric power generation system 450 can take into account the desired or needed inlet conditions for electric power generation system 452. In some embodiments, the turboexpanders 450 and 452 can be configured to allow more ready use of the declining pressures produced by the well over its life. For example, in the embodiment of FIG. 3, when the pressure produced by the well 304 is greater than can be handled by the turboexpander of the electric power generation system 350, the pressures are regulated down to the efficient operating pressure range of the turboexpander, effectively decreasing the amount of energy available in the flow for conversion into electric power. If the turboexpander were to be configured to have a higher operating pressure range, the lower end of the operating pressure range would also likely increase. Thus, as the well pressure declines, the point at which the well pressure will no longer efficiently drive the turboexpander of the electric power generation system 350 would be reached sooner in the well's life. By providing the turboexpander of the electric power generation system 450 configured to operate at higher pressures, for example, the system 400b can generate more electric power by harnessing the higher pressures with the turboexpander of the electric power generation system 450. Then, as the pressures decline to the point at which the well pressure will no longer efficiently drive the turboexpander of the electric power generation system 450, the electric power generation system 450 can be isolated from the flow, and electric power generated at lower pressures with only the turboexpander of the parallel electric power generation system 452. Notably, although the system 400b is described herein with only two electric power generation systems, additional, such as three, four or more could be provided, each with two separate flow paths and the valves as described above. Two or more in the set could be identically configured or all could be differently configured, for example, with successively lower operating ranges for each downstream electric power generation system. In some embodiments, there may be additional power generation systems installed in parallel to each other at one or more operating regimes.

In another example, by providing the turboexpander of the electric power generation system 450 and 452 in parallel, pressures that are too high for either of the electric power generation system 450 and 452 to handle alone, the system 400b can generate more electric power by dividing the higher pressures between the turboexpander of the electric power generation system 450 and the turboexpander of the electric power generation system 452. Then, as the pressures decline to the point at which the well pressure will no longer efficiently drive the turboexpander of the electric power generation system 450, the electric power generation system 450 can be isolated from the flow, and electric power generated at lower pressures with only the turboexpander of the parallel electric power generation system 452. Notably, although the system 400b is described herein with only two electric power generation systems, additional, such as three, four or more could be provided, each with two separate flow paths and the valves as described above. Two or more in the set could be identically configured or all could be differently configured, for example, with successively lower operating ranges for each parallel electric power generation system. In some embodiments, there may be additional power generation systems installed in parallel or series to each other at one or more operating regimes.

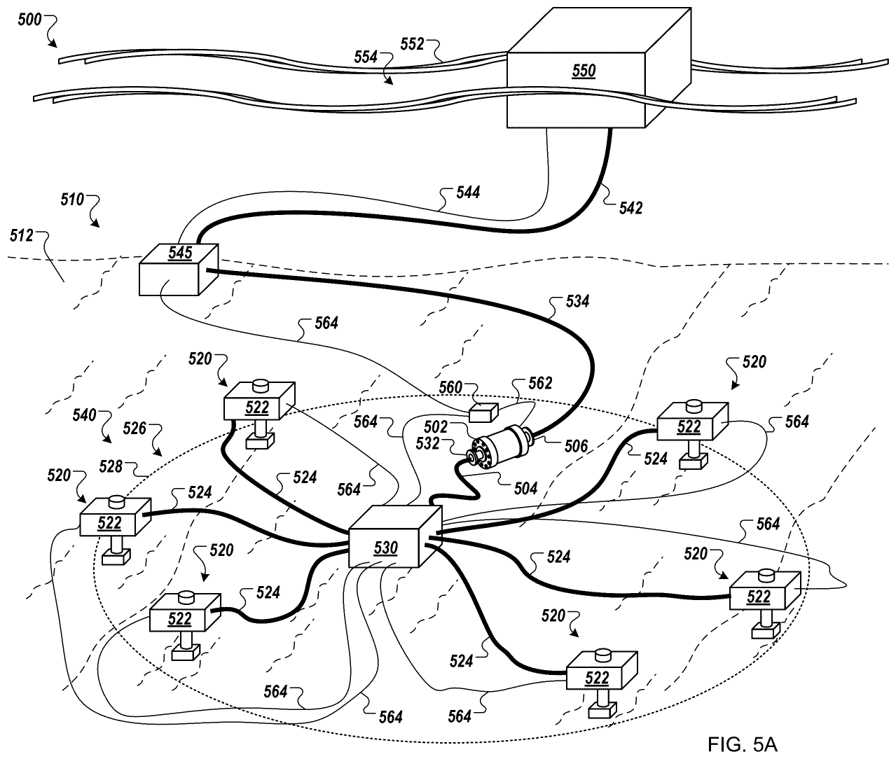

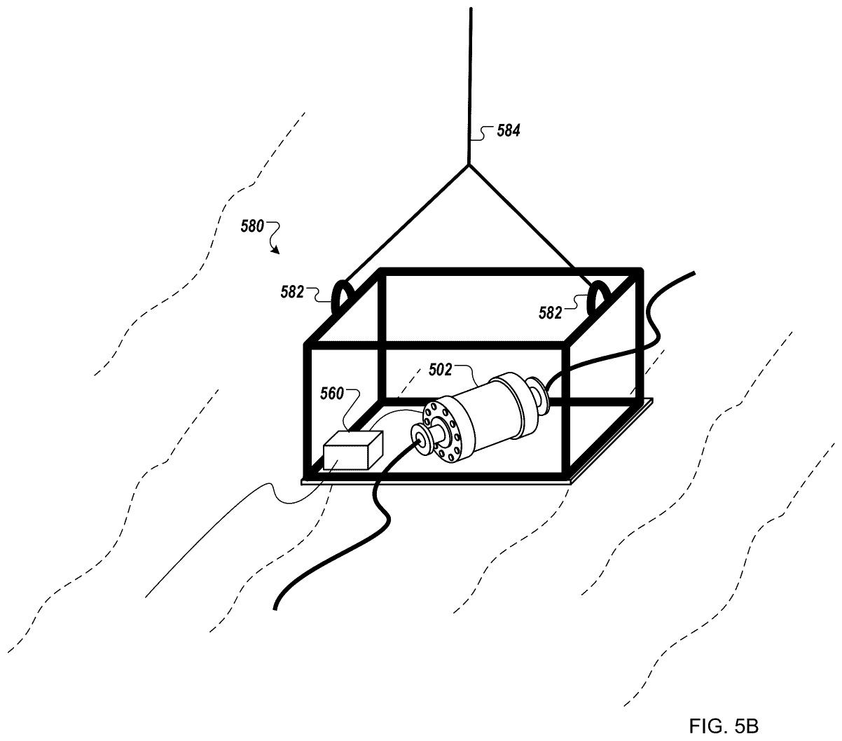

FIG. 5A is a conceptual diagram of an example subsea gas well system 500 coupled to a power grid 540 in accordance with embodiments of the present disclosure. As discussed in more detail below, the power grid 540 may be a microgrid or the system 500 may be directly coupled to one or more pieces of equipment powered by its output. The subsea gas well system 500 includes an electric power generation system 502. In some embodiments, the electric power generation system 502 can be the example electric power generation system 100 or an embodiment thereof. For example, the electric power generation system 502 can include a turboexpander that is substantially similar to the example electric power generation system 102 in which the turboexpander housing 112 is hermetically sealed to protect internal components from ingress of seawater while deeply submerged in a subsea oceanic environment, such as on or near an ocean floor 512 proximal to a subsea natural gas production site 510. As will be discussed in the description of FIG. 5B, in some embodiments, the electric power generation system 502 can be arranged as part of a skid assembly.

The system 500 includes several subsea gas wells 520, each having a subsea tree 522 (e.g., a wellhead). Gas produced by the subsea gas wells 520 flows from the subsea trees 522 through gas pipelines 524 to a gas manifold 530. The subsea gas wells 520 and the gas manifold 530 are arranged as a subsea production site 526 (e.g., well field) having a predetermined perimeter 528, and the power grid 540 is configured to distribute power within the subsea production site 526. The gas manifold 530 combines the gas flows from the gas pipelines 524, and the combined gas flow flows through a gas pipeline 532 to an inlet flow line 504 that is hermetically sealed to the housing of the electric power generation system 502. In some embodiments, the gas manifold 530 can include a gas controller that is configured to provide control commands to other components of the system 500, such as the subsea trees 522.

The electric power generation system 502 is arranged in the subsea production site 526, within the perimeter 528, and acts as an electric generator by converting kinetic energy to rotational energy from gas expansion into electrical energy. The expanded gas from the electric power generation system 502 flows out an outlet flow line 506 that is hermetically sealed to the housing of the electric power generation system 502 and through a gas pipeline 534 to a gas connection control system 545. In some embodiments, the gas connection control system 545 can provide control commands to other components of the system 500. In some embodiments, the gas connection control system 545 can provide a disconnectable and reconnectable coupling between the gas pipeline 534 and a gas umbilical line 542, through which gas can flow to a gas production platform 550 at a surface 552 of the ocean 554. In some embodiments, the gas flow paths of the system 500 can be hermetically sealed to prevent ingress of seawater.

Electrical power generated by the electric power generation system 502 flows to a power electronics module 560 through a power line 562. In some embodiments, the power electronics module 560 can be the example power electronics module 118 or an embodiment thereof. For example, the power electronics module 560 can include a VSD and MBC into a hermetically sealed cabinet that is configured to protect internal components from ingress of seawater at subsea pressures.

Electrical power generated by the electric power generation system 502 flows to the power grid 540. In operation, the subsea gas well system 500 is partly or entirely self-powered, and the electric power generation system 502 can be configured to supply some, most, or all of the electrical power needed by the power grid 540. Local, subsea generation of power can be more efficient, reliable, and/or economical than supplying power from a surface generator. For example, the electric power generation system 502 is far closer to the power consuming components of the subsea production site 526 (e.g., the subsea trees 522, the gas manifold 530) than a generator located at the gas production platform 550. As such, the electrical conductors between the electric power generation system 502 and the electrical loads of the subsea production site 526 can be kept short (e.g., less than a diameter of the perimeter 528) and losses associated with power transmission can be reduced.

In some implementations, the electric power generation system 502 can provide electrical power more efficiently than other (e.g., surface-based) power generation systems. For example, instead of burning combustible fuels or requiring the installation of large solar arrays or wind turbines to generate electricity, the electric power generation system 502 can produce electricity while simultaneously producing gas. The electric power generation system 502 harnesses and takes advantage of the inherent potential energy of the pressure of the gas being produced by the subsea trees 522 to spin the turboexpander. A side effect of the power generation process is, as the pressure of the gas spins the turboexpander to produce electricity, the electric power generation system 502 reduces and/or regulates of the outlet pressure and/or flow of the gas. In previous embodiments, a separate pressure and/or flow regulator may be needed (e.g., to prevent over-pressurization of the gas pipeline 534), whereas in the illustrated example, the electric power generation system 502 can perform useful work while also providing pressure and/or flow regulation.

The electric power generation system 502 produces substantially carbon-free or carbon-neutral power. For example, while the natural gas passing through the electric power generation system 502 is carbon-based, the process of generating electrical power does not combust or otherwise consume the natural gas and therefore does not contribute to the production of carbon-based emissions. Furthermore, use of the electric power generation system 502 can prevent or reduce the production of carbon byproducts. For example, the electric power generation system 502 can produce power as a by-product of natural gas flow, instead burning a portion of the natural gas (or other carbon-based fuel) at the surface in order to spin a generator and send the produced power back down to the equipment at the sea floor, wherein such carbon-based power production is also negatively affected by the transmission losses that are inherent in long-distance power transmission.

In another example, some motor drivers (e.g., a VSD motor driver) can consume significant amounts of power and deliver motor drive signals as multiple parallel electrical phase signals. If the motor driver is located subsea and obtains power remotely from the surface, there can be a loss of power to the driver. If the motor driver is located and powered at the surface, and is connected remotely to subsea motors, then the parallel driver signals can lose amplitude (e.g., due to transmission losses) or lose fidelity (e.g., dispersion of pulse-width-modulated signals due to capacitance, induction, and/or crosstalk within and between the parallel connections) that can reduce the operational capabilities of the motors. However, by locating the motor driver subsea near the motor it is configured to drive, and by powering it locally from the electric power generation system 502, such power losses and operational problems can be reduced or eliminated.

Electrical power generated by the electric power generation system 502 also flows to the gas connection control system 545 and to the manifold 530 through power lines 564. In some embodiments, the gas connection control system 545 can provide a disconnectable and reconnectable coupling between the power line 564 and an electrical umbilical line 544, through which electrical power can flow to the gas production platform 550. Electrical power provided to the manifold 530 is distributed to the subsea trees 522 through power lines 564.

In the illustrated example, the electric power generation system 502 can generate electrical power from the kinetic energy inherently present in the gasses produced at the subsea natural gas production site 510 and provide that electrical power for local use by equipment at the subsea natural gas production site 510 and/or the gas production platform 550. This provides an advantage over previous configurations in which electrical power is generated at a surface facility and is provided down to the equipment at the sea floor through long umbilical power lines that can induce power losses and are subject to disconnection (e.g., during storms) that can leave the subsea equipment without power until such connections can be reconnected. In some embodiments, the electrical flow paths of the system 500 can be hermetically sealed to prevent ingress of seawater.

In some implementations, the subsea production site 526 can be arranged to reduce or minimize damage from outside forces, such as a ship dropping anchor or dragging an anchor. For example, the subsea production site 526 can be arranged to have the most complex or delicate components near the center of the subsea production site 526 and have tougher and/or simpler components arranged near the perimeter 528. In such an example, if a ship were to drag an anchor into the subsea production site 526, the outer components of the well field may stop or resist the movement of the anchor before the anchor reaches the inner components.

FIG. 5B is a conceptual diagram of an example subsea skid 580. The subsea skid 580 is a structure (e.g., a frame, shell, container) within or upon which a collection of components, including the electric power generation system 502 and the power electronics module 560 in the illustrated example, can be arranged or affixed. The subsea skid 580 includes a collection of attachment points 582 to which a cable 584 can be removably attached. In some embodiments, other components and equipment (e.g., manifold, subsea pump) can be mounted together or separately on the subsea skid 580

In some embodiments, the subsea skid 580 can be used to arrange and interconnect the electric power generation system 502 and the power electronics module 560 on shore or elsewhere out of the water, where the components are easy and safe to access (e.g., without diving equipment), and deployed as an integrated system to the sea floor. In some embodiments, the subsea skid 580 can be deployed by connecting the cable 584 to the attachment points 582 or elsewhere on the subsea skid 580 and lowered (e.g., using a crane or winch on a boat or ship) to a predetermined location on the sea floor, such as the example subsea production site 526 of FIG. 5A or between two of the subsea trees 522.

In some embodiments, the subsea skid 580 can provide protection for internal components. For example, the subsea skid 580 can prevent direct contact between the electric power generation system 502 and/or the power electronics module 560, and external objects such as rocks, corals, ship anchors, falling debris, or other objects that could contact and/or damage the electric power generation system 502 and/or the power electronics module 560.

In the illustrated example, the electric power generation system 502 and the power electronics module 560 are mounted on the same subsea skid 580. In some embodiments, the electric power generation system 502 can be mounted on a first subsea skid and the power electronics module 560 and/or other components can be mounted on a second, different subsea skid.

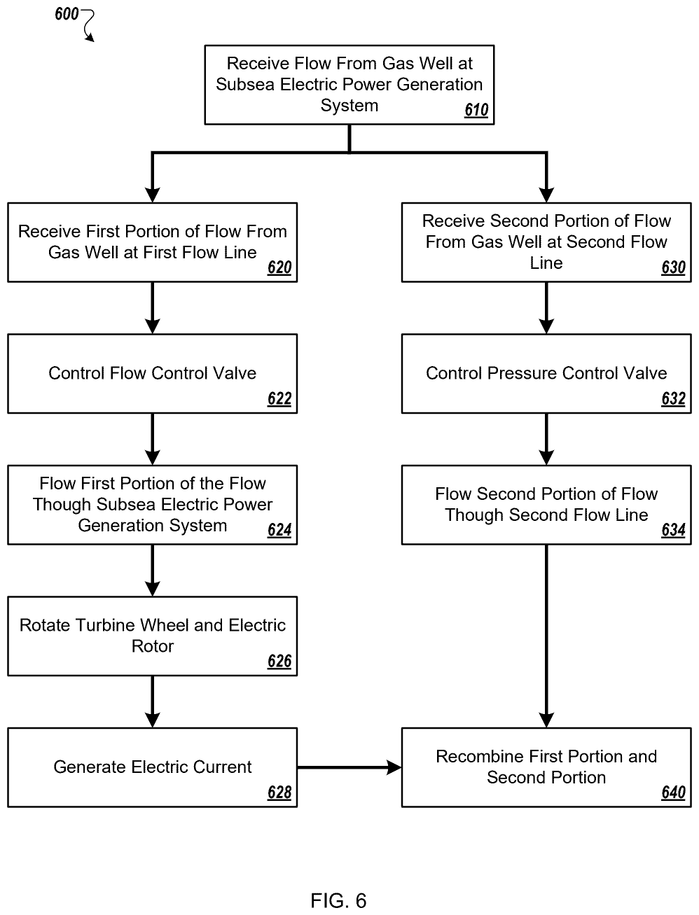

FIG. 6 is a flow diagram of an example process 600 for operating an example subsea energy recovery system with an electric power generation system in accordance with the concepts herein. In some implementations, the process 600 can be performed by example subsea gas well system 500 of FIG. 5A.

At 610, gas flow from a subsea gas well is received at a first flow line of a subsea electric power generation system residing on a subsea production site of the subsea gas well. The subsea electric power generation system includes a turbine wheel configured to receive gas produced from the subsea gas well and rotate in response to expansion of the gas flowing into an inlet of the turbine wheel and out of an outlet of the turbine wheel, a rotor coupled to the turbine wheel and configured to rotate with the turbine wheel, a stationary electric stator, the rotor and electric stator defining an electric generator configured to generate current upon rotation of the rotor within the electric stator, and a hermetically sealed housing enclosing the turbine wheel, the rotor, and the electric stator and hermetically sealed inline in the first flow line so that received flow flows through the turbine wheel and over the electric stator. For example, gas flow from the example subsea gas wells 520 can be received at the inlet flow line 504 of the example turboexpander 502.

In some implementations, receiving flow from the subsea gas well at a first flow line can include receiving flow from a subsea gas manifold coupled to a collection of subsea trees of a collection of subsea gas wells and configured to receive gas produced from the collection of subsea gas wells. For example, the gas manifold 530 can receive gas from the subsea trees 522 of the subsea gas wells 520.

At 620, at least a first portion of the flow from the subsea gas well flows through the first flow line. At 622 a flow control valve is controlled to control flow of the first portion. At 624, the first portion flows through a subsea electric power generation system. For example, a portion of the high-pressure process gas 120 can be directed to flow into and through the turboexpander 102 through the flow control system 126.

At 626, the first portion rotates the turbine wheel and the rotor. At 628, electrical current is generated based on rotation of the rotor within the electric stator. For example, the turboexpander 102 can act as an electric generator by converting kinetic energy to rotational energy from gas expansion through the turbine wheel 104 and generating electrical energy. Rotation of the turbine wheel 104 can be used to rotate the rotor 108 within the stator 110, which can then generate electrical energy.

At 630, a second portion of flow is received from the subsea gas well at a second flow line configured to provide an alternate flow path for the gas around the subsea electric power generation system. For example, a portion of the portion of the high-pressure process gas 120 can be directed to flow to the pressure control valve 130. turboexpander 102 through the flow control system 126

At 632, a pressure control valve in the second flow line is controlled. At 634, the second portion is flowed through the second flow line. For example, the pressure control valve 130 can be controlled to vary gas flow through the gas pipeline 170.

At 640, the first portion and the second portion are recombined downstream of the subsea electric power generation system. For example, gas can flow from the turbine wheel 104 to the axial gas outlet 156. The gas can then flow through the generator and out of the outlet 152, where the gas rejoins the gas pipeline 170.

In some embodiments, the hermetically sealed housing can be hermetically sealed to a remainder of the first flow line. For example, the example gas pipeline 532 can be hermetically sealed to the inlet flow line 504, and the example gas pipeline 534 can be hermetically sealed to the outlet flow line 506.

In some embodiments, the rotor can be a permanent magnet rotor. For example, the example turboexpander 102 can include a high-performance, high-speed permanent magnet generator with an integrated radial in-flow expansion turbine wheel 104.

In some embodiments, the subsea gas well can include a flow control valve in the first flow line upstream of the subsea electric power generation system. For example, the example flow control system 126 can include a flow or mass control valve and an emergency shut off valve.

In some embodiments, the inlet flow line can be configured to directly couple to the subsea tree to receive gas produced from the subsea gas well. In some implementations, receiving flow from the subsea gas well at a first flow line comprising a subsea electric power generation system residing on a subsea production site of the subsea gas well can include receiving, at an inlet flow line directly coupled to the subsea gas well, gas produced from the subsea gas well. For example, the example turboexpander 502 of FIG. 5 can be configured to receive produced gas directly from the subsea trees 522 instead of the manifold 530.

In some implementations, the process 600 can include providing generated current to one or more of a subsea gas well control system, a subsea gas manifold control system, a subsea gas connection control system, or an electrical load at or above a surface of water. For example, the example turboexpander 502 of FIG. 5 can generate electrical power from gas flows and provide the generated power to the gas manifold 530, the subsea trees 522, the gas connection control system, the power electronics module 560, and/or the gas production platform 550.

Although a few implementations have been described in detail above, other modifications are possible. For example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A subsea energy recovery system for generating electric power, comprising:
an inlet flow line configured to receive gas produced from a subsea gas well; and
a first flow line connected to the inlet flow line and configured to receive the gas, the first flow line comprising a subsea electric power generation system, the subsea electric power generation system configured to reside subsea on a subsea production site of the subsea gas well and receive the gas through the first flow line, the subsea electric power generation system comprising:
a turbine wheel configured to receive the gas and rotate in response to expansion of the gas flowing into an inlet of the turbine wheel and out of an outlet of the turbine wheel;
a rotor coupled to the turbine wheel and configured to rotate with the turbine wheel;
a stationary electric stator, the rotor and stationary electric stator defining an electric generator configured to generate current upon rotation of the rotor within the stationary electric stator; and
a hermetically sealed housing enclosing the turbine wheel, the rotor, and the stationary electric stator and hermetically sealed inline in the first flow line so that received flow flows through the turbine wheel and over the stationary electric stator; and
a second flow line coupled to the inlet flow line to receive the gas and provide an alternate flow path for the gas around the subsea electric power generation system, the second flow line comprising a pressure control valve, and where the first flow line and the second flow line are coupled downstream of the subsea electric power generation system to recombine flow from the first and the second flow lines.

2. The subsea energy recovery system of claim 1, comprising a flow control valve in the first flow line upstream of the subsea electric power generation system.

3. The subsea energy recovery system of claim 1, further comprising a subsea gas manifold configured to receive gas produced from a plurality of subsea trees of a plurality of subsea gas wells comprising the subsea gas well, wherein the inlet flow line is configured to receive gas from the subsea gas manifold.

4. The subsea energy recovery system of claim 1, wherein the inlet flow line is configured to receive gas directly from a subsea tree of the subsea gas well.

5. The subsea energy recovery system of claim 1, wherein the electric generator is configured to provide generated current to one or more of:
a subsea tree of the subsea gas well;
a subsea gas manifold;
a subsea gas connection control system; or
an electrical load at or above a surface of water.

6. The subsea energy recovery system of claim 1, further comprising a least one subsea electrical load configured to reside subsea on the subsea production site and configured to receive the generated electric current.

7. The subsea energy recovery system of claim 1, wherein the electric generator is arranged within a predefined perimeter of the subsea production site.

8. A method of recovering energy and generating power from a flow from a subsea gas well, comprising:
receiving flow from the subsea gas well at a first flow line comprising a subsea electric power generation system residing on a subsea production site of the subsea gas well and comprising:
a turbine wheel configured to receive gas produced from the subsea gas well and rotate in response to expansion of the gas flowing into an inlet of the turbine wheel and out of an outlet of the turbine wheel;
a rotor coupled to the turbine wheel and configured to rotate with the turbine wheel;
a stationary electric stator, the rotor and stationary electric stator defining an electric generator configured to generate current upon rotation of the rotor within the stationary electric stator; and
a hermetically sealed housing enclosing the turbine wheel, the rotor, and the stationary electric stator and hermetically sealed inline in the first flow line so that received flow flows through the turbine wheel and over the stationary electric stator;
flowing at least a first portion of the flow from the subsea gas well through the first flow line and the subsea electric power generation system;
rotating, by the first portion, the turbine wheel and the rotor;
generating current based on rotation of the rotor within the stationary electric stator;
receiving a second portion of flow from the subsea gas well at a second flow line configured to provide an alternate flow path for the gas around the subsea electric power generation system;
controlling a flow control valve in the first flow line and a pressure control valve in the second flow line;
flowing the second portion through the second flow line; and
recombining the first portion and the second portion downstream of the subsea electric power generation system.

9. The method of claim 8, wherein the hermetically sealed housing is hermetically sealed to a remainder of the first flow line.

10. The method of claim 8, wherein the flow control valve in the first flow line is arranged upstream of the subsea electric power generation system.

11. The method of claim 8, wherein receiving flow from the subsea gas well at the first flow line comprising the subsea electric power generation system residing on the subsea production site of the subsea gas well further comprises receiving, by a subsea gas manifold, flow from a plurality of subsea gas wells comprising the subsea gas well, wherein the inlet is configured to receive gas from the subsea gas manifold.

12. The method of claim 8, wherein the inlet is configured to receive gas directly from a subsea tree of the subsea gas well.

13. The method of claim 8, wherein receiving flow from the subsea gas well at the first flow line comprising the subsea electric power generation system residing on the subsea production site of the subsea gas well further comprises receiving, at an inlet flow line directly coupled to the subsea gas well, gas produced from the subsea gas well.

14. The method of claim 8, comprising providing generated current to one or more of:
a subsea gas well control system;
a subsea gas manifold control system;
a subsea gas connection control system; or
an electrical load at or above a surface of water.

15. The method of claim 8, wherein receiving flow from the subsea gas well at the first flow line comprises receiving flow from a subsea gas manifold coupled to a plurality of subsea trees of a plurality of subsea gas wells comprising the subsea gas well and configured to receive gas produced from the plurality of subsea gas wells.

16. The method of claim 8, further comprising receiving the generated electric current by a least one subsea electrical load configured to reside subsea on the subsea production site.

17. The method of claim 8, further comprising arranging the electric generator within a predefined perimeter of the subsea production site.

18. A system, comprising:
a subsea turbogenerator coupled to a subsea tree to couple inline between a conduit between a subsea tree and a gas pipeline away from the subsea tree, the subsea turbogenerator configured to receive a gas from the subsea tree; and
a second line from the subsea tree to the gas pipeline bypassing the subsea turbogenerator.

19. The system of claim 18, further comprising a power cable configured to conduct electric current from the subsea turbogenerator to a subsea component.

20. The system of claim 18, further comprising a power cable configured to conduct electric current from the subsea turbogenerator to a surface component.

21. The system of claim 18, wherein the subsea turbogenerator is configured to receive the gas directly from the subsea tree.
